(19) United States
(12) Patent Application Publication
(10) Pub. No.: US 2005/0110412 A1
(43) Pub. Date: May 26, 2005

(54) Phosphors for a plasma display panel, and a plasma display panel using the same

(76) Inventor: Sung-Yong Lee, Suwon-si (KR)

Correspondence Address: CHRISTIE, PARKER & HALE, LLP, PO BOX 7068, PASADENA, CA, 91109-7068, US

(21) Appl. No.: 10/966,363

(22) Filed: Oct. 15, 2004

(30) Foreign Application Priority Data
Oct. 16, 2003 (KR) 10-2003-0072331

(51) Int. Cl. H01J 17/49

(52) U.S. Cl. 313/587; 313/486

(57) ABSTRACT

A plasma display panel, and phosphors for a plasma display panel are disclosed. The plasma display panel comprises first and second substrates each facing each other. Discharge sustain electrodes are positioned on the first substrate. A dielectric layer covers the discharge sustain electrodes. A MgO protective layer covers the dielectric layer. Address electrodes are positioned on the second substrate. Barrier ribs are arranged between the first and second substrates, creating a plurality of discharge cells. A phosphor layer is positioned on the second substrate between the barrier ribs in each discharge cell. The phosphor layer comprises a first non-fluorescent material and a second fluorescent material. The first fluorescent material has a MgO sticking coefficient greater than that of the second fluorescent material.

### CROSS-REFERENCE TO RELATED APPLICATION(S)

The present application claims priority of Korean Patent Application No. 10-2003-0072331, filed Oct. 16, 2003, the entire disclosure of which is incorporated herein by reference.

### FIELD OF THE INVENTION

The present invention relates to phosphors for a plasma display panel, and more particularly to a plasma display panel comprising these phosphors which enhance luminance retention during plasma discharge.

### BACKGROUND OF THE INVENTION

Generally, a plasma display panel (“PDP”) is a device that displays images through plasma discharge. Plasma discharge is generated between electrodes positioned on PDP substrates by applying voltage to those electrodes. This plasma discharge emits ultraviolet rays which excite phosphors in a predetermined pattern, thereby displaying the desired images on the PDP. PDPs are classified into three types: an AC type, a DC type, and a hybrid type.

FIG. 3 is an exploded perspective view of a common AC type PDP. The PDP 100 comprises a bottom substrate 111, address electrodes 115 positioned on the bottom substrate, a dielectric layer 119 covering the address electrodes 115, a plurality of barrier ribs 123 positioned on the dielectric layer 119, and a phosphor layer 125 coated on the dielectric layer between the barrier ribs 125. The barrier ribs 123 serve to maintain discharge distance and prevent crosstalk between adjacent discharge cells.

The AC type PDP also comprises sustain electrodes, including common electrodes 104 and scanning electrodes 105 formed on a top substrate 113. These sustain electrodes are positioned on the top substrate 113 perpendicular to the address electrodes 115 on the bottom substrate 111. A dielectric layer 121 is formed over the common electrodes 104 and scanning electrodes 105. A MgO protective layer 127 is formed over the dielectric layer 121.

The plasma discharge is initiated by the application of driving voltages to the address electrodes 115 and the common electrodes. During this address discharge, the address electrodes 115 operate as the positive electrodes while the common electrodes 104 operate as the negative electrodes. Accordingly, the discharge gas ions within the discharge cells move toward the top substrate adjacent the common electrodes 104, and the electrons move toward the bottom substrate adjacent the address electrodes 115. The ions and electrons then accumulate at dielectric layers 121 and 119, respectively, giving dielectric layers 121 and 119 opposing polarities. The charges accumulated at dielectric layers 119 and 121 reduce the plasma discharge by reducing the net space potential between the common electrodes 104 and address electrodes 105, thereby terminating the address discharge.

After termination of the address discharge, a relatively small amount of electrons accumulate adjacent the common electrodes 104, and a relatively large amount of ions accumulate adjacent the scanning electrodes 105. Consequently, wall charges are formed between the electrons adjacent the common electrodes 104 and the ions adjacent the scanning electrodes 105. These wall charges form wall voltages.

Discharge sustain voltages are then applied to the common electrodes 104 and scanning electrodes 105. During this sustain discharge, the common electrodes 104 operate as negative electrodes and the scanning electrodes 105 operate as positive electrodes. The sustain discharge is generated when the sum of the discharge sustain voltage and the wall voltage is greater than the discharge initiating voltage. After sustain discharge, positive and negative charges are formed, the positive charges accumulating at the common electrodes 104 and the negative charges accumulating at the scanning electrodes 105. The accumulation of the positive and negative charges at the common electrodes and scanning electrodes, respectively, gradually terminates the sustain discharge.

During either address discharge or sustain discharge, the MgO protective layer 127 reduces ion collisions due to discharge gas, thereby protecting the dielectric layer. However, the ion collisions cause sputtering of the MgO protective layer 127, resulting in detachment of Mg and O particles from the MgO protective layer 127. These detached Mg and O particles often attach to the front surface of the phosphor layer 125. This prohibits the ultraviolet rays from exciting the phosphors, thereby reducing the brightness of the images displayed.

### SUMMARY OF THE INVENTION

In one embodiment of the present invention, the phosphors used in the PDP comprise a material having a high MgO sticking coefficient, thereby enhancing the PDP's luminance retention. In this embodiment, the PDP comprises first and second substrates each facing each other. The first substrate comprises discharge sustain electrodes covered by a dielectric layer. The first substrate further comprises a MgO protective layer covering the dielectric layer. The second substrate comprises address electrodes covered by a dielectric layer.

The PDP further comprises barrier ribs between the first and second substrates which partition the PDP into a plurality of discharge cells. A phosphor layer is positioned between the barrier ribs and within each discharge cell. The phosphor layer comprises a first non-fluorescent material and a second fluorescent material. The first non-fluorescent material has a MgO sticking coefficient greater than that of the second fluorescent material.

The first non-fluorescent material is preferably selected from the group consisting of MgO, Al₂O₃, ZnO and mixtures thereof. The first non-fluorescent material is preferably present in the phosphor layer in an amount ranging from about 5% to about 30% by weight based on the total weight of the phosphor layer. Preferably, the particles of the first non-fluorescent material comprise nuclei, the majority of which are present at the surface of the phosphor layer.

### BRIEF DESCRIPTION OF THE DRAWINGS

The present invention, and many of its advantages, will be better understood by reference to the following detailed description when considered in conjunction with the accompanying drawings, wherein:

FIG. 1 is an enlarged cross-sectional view of a discharge cell of a PDP constructed in accordance with one embodiment of the present invention;

FIG. 2 is a graphical representation of the luminance retention of a PDP constructed in accordance with one embodiment of the present invention; and

FIG. 3 is an exploded perspective view of a discharge cell of a typical prior art PDP.

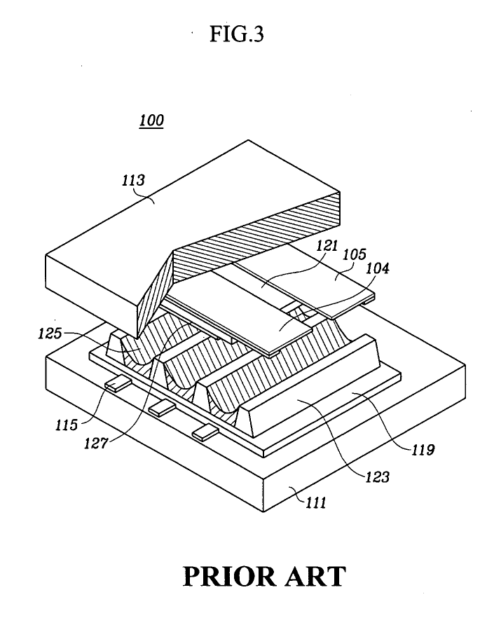

### DETAILED DESCRIPTION OF THE INVENTION

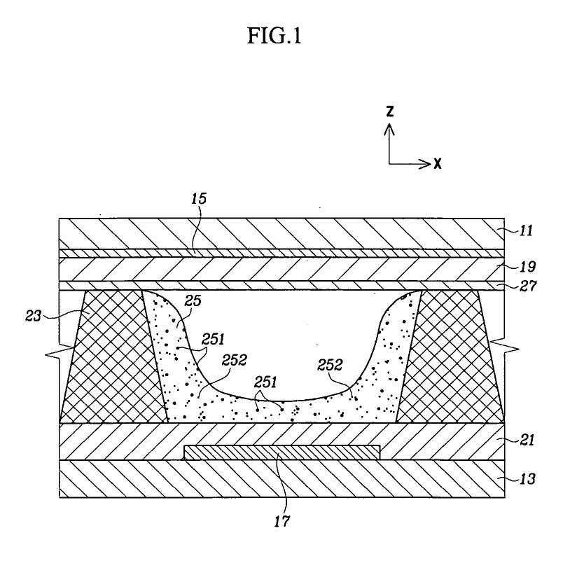

As shown in FIG. 1, a PDP according to the present invention comprises first and second substrates 11 and 13, respectively, spaced apart from each other by a distance, and positioned substantially parallel to each other. A plurality of address electrodes 17 are positioned on the surface of the second substrate 13. The second substrate 13 further comprises a dielectric layer 21 covering the address electrodes 17. A plurality of barrier ribs 23 are positioned on the dielectric layer 21 and extend a predetermined height from the second substrate in order to partition the second substrate 13 into a plurality of separate discharge cells. A phosphor layer 25 is formed within each discharge cell between the barrier ribs 23.

The first substrate 11 comprises a pair of discharge sustain electrodes 15 positioned on the first substrate 11 such that they extend substantially perpendicular to the address electrodes 17 positioned on the second substrate 13. A dielectric layer 19 is positioned on the first substrate 11 and covers the discharge sustain electrodes 15. The first substrate 11 also comprises a MgO protective layer 27 covering the dielectric layer 19.

In this embodiment, an address discharge is created when driving voltages are applied to the address electrodes 17 and discharge sustain electrodes 15. Upon the application of such voltages, the address electrodes 17 and discharge sustain electrodes 15 create wall charges within each discharge cell. Images are displayed on the PDP when current signals are alternately applied to the pair of discharge sustain electrodes corresponding to the discharge cell selected by the address discharge. This alternating application of current signals to the discharge sustain electrodes excites the discharge gas within the discharge cells to generate ultraviolet rays. The ultraviolet rays, in turn, excite the phosphors in the phosphor layer, thereby emitting visible rays, and displaying the desired images.

The phosphor layer comprises a first non-fluorescent material, and a second fluorescent material. The first non-fluorescent material has a MgO sticking coefficient greater than that of the second fluorescent material. The MgO sticking coefficient refers to the number of Mg and O particles stuck to the phosphor layer relative to the total number of particles in the phosphor layer. In particular, the sticking coefficient defines the ratio of Mg and O particles stuck to the phosphor layer to the total number of particles in the phosphor layer. MgO, Al₂O₃ and ZnO each have excellent MgO sticking coefficients. Also, these materials are similar to MgO in the number of valence electrons, making them interchangeable. Table 1, below, lists the sticking coefficients of non-limiting examples of various materials suitable for use as the first non-fluorescent material in the phosphor layer. Table 1 assumes that MgO has a sticking coefficient of 1.

TABLE 1

| Material | MgO sticking Coefficient |
|---|---|
| MgO | 1.0 |
| ZnO | 0.9 |
| La₂O₃ | 0.9 |
| Al₂O₃ | 0.9 |
| SiO₂ | 0.8 |
| Zn₂SiO₄:Mn green phosphor | 0.7 |
| YBO₃:Tb, (Y, Gd)BO₃:Tb green phosphor | 0.5 |
| (Y, Gd)BO₃:Eu⁺³ red phosphor | 0.5 |
| BaMgAl₁₀O₁₇:Eu⁺² blue phosphor | 0.7 |
| CaMgSiO₆:Eu⁺² blue phosphor | 0.7 |

A powder of the first non-fluorescent material is mixed with a paste of the second fluorescent material. Alternatively, powders of the first non-fluorescent material and the second fluorescent material are mixed together and then formed into a paste. The first non-fluorescent material is present in the phosphor layer in an amount ranging from about 5% to about 30% by weight based on the total weight of the phosphor layer. If the first non-fluorescent material is present in the phosphor layer in an amount less than about 5 wt %, brightness is not significantly improved. Also, if the first non-fluorescent material is present in an amount greater than about 30 wt %, the reduction in brightness that results from the sputtering of the MgO protective layer is exacerbated. The phosphor layer is then deposited between the barrier ribs and the PDP is constructed according to well-known procedures.

As shown in FIG. 1, the phosphor layer 25 comprises first non-fluorescent particles 251 and second fluorescent particles 252. In one embodiment, the second fluorescent particles 252 comprise (Y, Gd)BO₃:Eu⁺³ for red color, Zn₂SiO₄:Mn⁺² for green color, and BaMgAl₁₀O₁₇:Eu⁺² for blue color.

In this embodiment, the first non-fluorescent particles 251 comprise micro-nuclei, and are selected from the group consisting of MgO, ZnO, Al₂O₃, and mixtures thereof. The majority of the particles at the surface of the phosphor layer 25 comprise first non-fluorescent particles 251. This arrangement enables these first non-fluorescent particles 251 to attract the Mg and O particles that are detached from the MgO protective layer upon discharge. In particular, the Mg and O particles that become detached from the MgO protective layer during discharge mainly stick to the micro-nuclei of the first non-fluorescent particles 251. This arrangement significantly enhances brightness by reducing the area within the phosphor layer in which the detached Mg and O particles will stick. This reduction in the sticking area, in turn, reduces the rate of brightness reduction, thereby significantly enhancing the brightness of the PDP.

The following Experimental and Comparative Examples further illustrate the present invention and some of its advantages, but shall not be construed to limit the scope of the invention. In each Experimental and Comparative Example the luminance retention of the PDP was measured and the results obtained in the Experimental Examples were compared to those obtained in the Comparative Examples. Luminance retention refers to the ratio of brightness after a specified lapse of time to initial brightness, and is expressed as a percentage. Luminance retention is used to evaluate the degree of permanent afterimage. Permanent afterimage refers to the deterioration of phosphors that results from the display of a still image for a long time. As luminance retention is enhanced, the difference in brightness between the patterned (still image) portion and the non-patterned portion becomes so slight that the naked eye is incapable of distinguishing between the portions. In particular, the micro-nuclei of the first non-fluorescent material present at the surface of the phosphor layer reduce the rate at which the Mg and O particles stick to the phosphor layer, thereby enhancing brightness and improving the afterimage. Therefore, as luminance retention is enhanced, so is the permanent afterimage.

### EXPERIMENTAL EXAMPLE

A high molecular weight liquid solution was prepared by first dissolving a binder, nitroethyl cellulose (“NEC”), in a solvent to provide the proper viscosity, and then adding an optical initiator, a multifunctional monomer and various additives. Phosphor powder containing 20 wt % MgO as the first non-fluorescent material were added to the high molecular weight liquid solution. The solution was then stirred by a high speed stirrer. The phosphors were then uniformly diffused through a triple roller, forming a photosensitive phosphor paste while controlling viscosity. The phosphor paste was then coated between the barrier ribs and sintered to fabricate a PDP. Brightness was measured at 0 hours, 100 hours, 200 hours, 300 hours and 400 hours.

### COMPARATIVE EXAMPLE

A PDP was fabricated substantially the same as in the Experimental Example, except MgO powder was not added to the phosphors. Brightness was measured at the same intervals as in the Experimental Example.

Table 2, below, lists the brightness measurements and luminance retention calculations obtained in the Experimental and Comparative examples.

| | Time lapsed (hours) | | | | |
|---|---|---|---|---|---|
| | 0 | 100 | 200 | 300 | 400 |
| Experimental | 160 | 159 | 158 | 156 | 154 |
| Example - | | | | | |
| Brightness | | | | | |
| (cd/cm²) | | | | | |
| Experimental | 100.00 | 99.38 | 98.75 | 97.50 | 96.25 |
| Example - | | | | | |
| Luminance | | | | | |
| Retention | | | | | |
| (%) | | | | | |
| Comparative | 180 | 176 | 173 | 171 | 169 |
| Example - | | | | | |
| Brightness | | | | | |
| (cd/cm²) | | | | | |
| Comparative | 100.00 | 97.78 | 96.11 | 95.00 | 93.89 |
| Example - | | | | | |
| Luminance | | | | | |
| Retention | | | | | |
| (%) | | | | | |

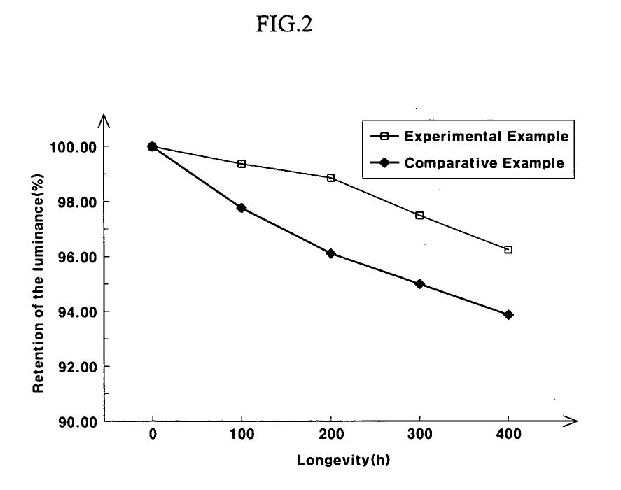

FIG. 2 is a graphical representation of the measurements listed in Table 2. The x-axis represents the time lapse in hours and the y-axis represents the luminance retention percentage. As shown in FIG. 2, the reduction in luminance retention of the PDP of the Experimental Example is slow, whereas the reduction in luminance retention of the PDP of the Comparative Example is considerably faster. Accordingly, the PDP containing the phosphor layer with 20 wt % MgO exhibits enhanced luminance retention and excellent discharge quality. Similar results are obtained with phosphor layers containing about 5% to about 30% by weight of MgO, Al₂O₃ or ZnO, each of which have excellent MgO sticking coefficients.

While the present invention has been described in detail with reference to the preferred embodiments, those skilled in the art will appreciate that various modifications and substitutions can be made thereto without departing from the spirit and scope of the present invention as set forth in the appended claims.

1. A plasma display panel comprising:
first and second substrates, each facing each other;
at least two discharge sustain electrodes positioned on the first substrate;
a dielectric layer positioned on the first substrate covering the at least two discharge sustain electrodes;
a MgO protective layer positioned on the first substrate covering the dielectric layer;
a plurality of address electrodes positioned on the second substrate;
a plurality of barrier ribs arranged between the first and second substrates, wherein the barrier ribs are positioned such that they define a plurality of discharge cells; and
a phosphor layer positioned on the second substrate within each discharge cell, the phosphor layer comprising a first non-fluorescent material and a second fluorescent material, wherein the first non-fluorescent material has a MgO sticking coefficient greater than a MgO sticking coefficient of the second fluorescent material.

2. The plasma display panel of claim 1, wherein the first fluorescent material is selected from the group consisting of MgO, Al₂O₃, ZnO and mixtures thereof.

3. The plasma display panel of claim 1, wherein the first non-fluorescent material is present in the phosphor layer in an amount ranging from about 5% to about 30% by weight based on the total weight of the phosphor layer.

4. The plasma display panel of claim 1, wherein the first non-fluorescent material is present in the phosphor layer as particles in the shape of nuclei, and a majority of the particles of the first non-fluorescent material is present at the surface of the phosphor layer.

5. Phosphors for a plasma display panel comprising a first non-fluorescent material and a second fluorescent material, wherein the first non-fluorescent material has a MgO sticking coefficient greater than a MgO sticking coefficient of the second fluorescent material.

6. The phosphors of claim 5, wherein the first non-fluorescent material is selected from the group consisting of MgO, Al₂O₃, ZnO and mixtures thereof.

7. The phosphors of claim 5, wherein the first non-fluorescent material is present in the phosphors in an amount ranging from about 5% to about 30% by weight based on the total weight of the phosphors.
